(19) United States
(12) Patent Application Publication
(10) Pub. No.: US 2010/0299651 A1
(43) Pub. Date: Nov. 25, 2010

(54) ROBUST TESTING FOR DISCRETE-TIME AND CONTINUOUS-TIME SYSTEM MODELS

(75) Inventors: GEORGIOS FAINEKOS, Chandler, AZ (US); Sriram Sankaranarayanan, Boulder, CO (US); Franjo Ivancic, Princeton, NJ (US); Aarti Gupta, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/708,651

(22) Filed: Feb. 19, 2010

Related U.S. Application Data
(60) Provisional application No. 61/179,418, filed on May 19, 2009.

(51) Int. Cl. G06F 9/44

(52) U.S. Cl. 717/104; 717/126

(57) ABSTRACT

A system and method for testing robustness of a simulation model of a cyber-physical system includes computing a set of symbolic simulation traces for a simulation model for a continuous time system stored in memory, based on a discrete time simulation of given test inputs stored in memory. Simulation errors are accounted for due to at least one of numerical instabilities and numeric computations. The set of symbolic simulation traces are validated with respect to validation properties in the simulation model. Portions of the simulation model description are identified that are sources of the simulation errors.

### RELATED APPLICATION INFORMATION

This application claims priority to provisional application Ser. No. 61/179,418 filed on May 19, 2009, incorporated herein by reference.

### BACKGROUND

1. Technical Field

The present invention relates to computer model verification, and more particularly to system and methods for testing computer models of discrete-time and continuous-time systems for robustness.

2. Description of the Related Art

Due to the ubiquitous availability of cyber-systems that interact with physical environments, there is a great need to develop technologies that target a whole system. Analyzing software for its correctness is needed to guarantee safety of many important embedded devices, such as medical devices, automobiles or airplanes. Due to the intrinsic complexity of floating-point operations and the possibility of negative effects on the safety of embedded devices, automated analysis tools are needed to reason about the correctness of programs that manipulate numbers represented in floating-point formats such as defined by the IEEE754 standard.

A model-based design flow is now the industry standard in the cyber-physical domain. Standard tools for model-based design include Matlab™, Simulink™, MapleSim™, Scade™, to name a few. These tools provide simulation capabilities which are extensively used by designers as the main design validation and verification methodology. Now instead of producing some initial design and then building a prototype in order to test the system, engineers can directly model the system in a software package and verify its behavior under a range of operating conditions. This process tremendously reduces the design cycle since it removes the need for building a prototype at the initial stages.

There are a variety of approaches to analyze correctness of model-based designs. For example, robust testing of hybrid system simulations does not consider computational issues of floating point representations. Test vector generation for model-based designs—often using Monte-Carlo based sampling techniques. Automatic generation of source code from a model may include running a program analysis tool such as Fluctuat for floating-point precision problems. Complete formal verification on hybrid systems, which is not scalable beyond few continuous variables, usually does not consider computational issues of floating point representations.

Even though model based development can save design time, there is still plenty of room for improvement. One of the tedious processes in model based design is the verification process. That is, how the design team can guarantee that their model of the system behaves according to a set of (formal) specifications. The current practice involves extensive testing under different operating conditions until the team is satisfied that their design adheres to some standards or requirements.

This is a tedious process and one can never be sure that all the critical combinations of operating conditions have been tested. In addition, the user cannot quantify how interesting the test case was. For example, it may be the case that the operating conditions under consideration generate a behavior that it is not robust. Under some small perturbation—usually due to uncertainty or internal computation errors—the real trajectories could diverge from the simulated one and cause catastrophic results.

### SUMMARY

A system and method for testing robustness of a simulation model of a cyber-physical system includes computing a set of symbolic simulation traces for a simulation model for a continuous time system stored in memory, based on a discrete time simulation of given test inputs stored in memory. Simulation errors are accounted for due to at least one of numerical instabilities and numeric computations. The set of symbolic simulation traces are validated with respect to validation properties in the simulation model. Portions of the simulation model description are identified that are sources of the simulation errors.

A system and method for testing robustness of a simulation model of a cyber-physical system includes extracting a symbolic representation of a model description stored in memory to be tested, by applying given test inputs. A set of simulation traces corresponding to the symbolic representation are generated. The simulation traces are validated to account for errors due to at least one of numerical instabilities and numeric computations. Portions of the model description that are sources of the errors are identified. Mixed discrete/continuous-time hybrid systems are employed as models of cyber-physical systems. Continuous-time only systems are also employed as models of the cyber-physical systems as well.

A system for testing robustness of a cyber-physical model includes a symbolic model extractor stored in memory storage and configured to generate a symbolic representation of a model description by applying test inputs stored in the memory storage, and a test simulator configured to run tests on the model description to generate simulation traces for the model description. A validated simulator is configured to generate and validate a set of simulation traces corresponding to the symbolic representation, to account for errors due to at least one of numerical instabilities and numeric computations, the validated simulator including a self-validated arithmetic function library to handle the numerical instabilities and numeric computations such that portions of the model description are identified by the validated simulator that are sources of the errors.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an illustrative continuous-time model to demonstrate the present principles;

FIG. 2 is a block diagram showing another illustrative continuous-time model to demonstrate the present principles;

FIG. 3 is a block/flow diagram showing an illustrative system/method for testing robustness of models in accordance with the present principles;

FIG. 4 is a block/flow diagram showing an illustrative system/method for performing traditional and validated testing in accordance with the present principles;

FIG. 5 is a block/flow diagram showing an illustrative system/method for determining robustness warnings of models in accordance with another illustrative embodiment; and

FIG. 6 is a block/flow diagram showing a validated simulator in greater detail in accordance with an illustrative embodiment.

### DETAILED DESCRIPTION OF PREFERRED EMBODIMENTS

A framework for determining correctness and robustness of simulations of hybrid systems is provided. The focus is on simulations generated from model-based design environments and, in particular, Simulink™, although the present teachings may be directed to other model-based systems. Correctness and robustness of the simulation is guaranteed against floating-point rounding errors and system modeling uncertainties. Self-validated arithmetic, such as interval and affine arithmetic, are employed for guaranteed simulation of discrete-time hybrid systems. In the case of continuous-time hybrid systems, self-validated arithmetic is utilized for reachability computations.

Given an arbitrary Simulink™ model with inputs, non-linearities, parameters, discrete-time and continuous-time blocks, we create a linearized symbolic model for each execution time step. We then rerun the user-provided test inputs in the symbolic model and test for robustness of the test inputs in a floating-point aware computation model and execution traces reported by Simulink™. This analysis can reveal numerical instabilities of a controller or of the numeric computations due to the use of floating-point semantics.

Robustness of a particular simulation is considered under system uncertainties, under possible uncertain operating conditions and due to numerical and internal computation errors. Ignoring such sources of errors can have catastrophic consequences. For example consider the case of the Patriot missile defense system. These missile systems are deployed to intercept incoming hostile aircraft or missiles. In brief, the software that controls the system computes the future position of the incoming missile based on the velocity and the last position as returned by the radar. However, the time was computed in increments of 0.1 sec, a number which could not be accurately represented in the underlying 24-bit fixed-point register. That caused a drift in the computed times when the system was operational for long hours and the result was that the defense system could not track and intercept the incoming missiles.

As another example, consider the function

$$f ( a , b ) = ( 333.75 - {a}^{2} ) {b}^{6} + {a}^{2} ( 11 {a}^{2} {b}^{2} - 121 {b}^{4} - 2 ) + 5.5 {b}^{8} + \frac{a}{2 b}$$

$$with a = 77617 and$$

b=33096. Using round-to-nearest 1×10⁻⁷⁵⁴ arithmetic, the ƒ function evaluates to (under different precision):

| | |
|---|---|
| 1.172604 | (32-bit) |
| 1.1726039400531786 | (64-bit) |
| 1.1726039400531786318588349045201838 | (128-bit). |

By increasing the precision, we seem to derive more accurate results. However, this is deceiving since not even the sign is correct in the above computations. The actual result, within one unit of the last digit, is ƒ(a, b)=−0.827396059946821368141165095479816. These two examples demonstrate that simulations could very well have undetected functional errors without the existence of any correctness errors (bugs) in the model. For such computation errors and, also, for model uncertainties, a framework is provided for detecting the robustness of these simulations.

A suite of tools have been developed illustratively for the Matlab™ environment for testing the robustness of discrete and continuous-time Simulink™ models. Advantageously, the Simulink™ model does not have to be translated into some other equivalent formalism, but we operate directly on the Simulink™ model. Towards this objective, we have also produced the following results and implementations. First, we have built an AALab (Affine Arithmetic Laboratory). AALab is an Affine Arithmetic (AA) toolbox in Matlab™ that allows AA object manipulation with floating-point rounding control in a transparent way to the user. Next, we have refined the theory of linear system reachability to guarantee the correctness of Simulink™ numerical simulations under model uncertainties and, under floating-point rounding uncertainties.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

The notion of robustness can have different meanings under different contexts. In the context of system simulation and testing, a robust trajectory would be one that under small perturbations would exhibit the same qualitative behavior. In certain cases, such questions can be answered by control theory even under the presence of floating-point rounding or quantization errors. However in general, this problem cannot be addressed analytically in systems where the low level system dynamics are governed by complex high-level logic such as in hybrid automata. We approach the problem from a testing perspective. Given a model of a system and some initial conditions and parameter values, we would like to detect points in time where the simulation trajectory of the system does not capture the intended behavior.

Problem 1: Given a discrete-time Simulink™ model D and a set of uncertain initial conditions X₀ and parameters P, determine points in time when the simulation trajectory is not robust. In this problem, the Simulink model D already contains the initial tₒ and final tₙ simulation times as well as the initial conditions x₀ and parameter values p. Formally speaking, system D can be captured by a system of difference equations ƒⱼ^{d}, j∈J_{d} such that: x(k+1)=ƒⱼ^{d}(x(k),u(k),p,k) (1) where k∈N is the current point in time x:N→ [symbol] , is the solution of system Eq. (1) (we assume that a unique solution exists), u:N→ [symbol] is an input to the system and p∈P⊂ [symbol] is a vector modeling the parameters of the system. Here, N denotes the set of the natural numbers and [symbol] the set of the real numbers. In system Eq. (1), at each point in time k, the system dynamics are governed by a unique difference equation ƒⱼ^{d}, i.e., the system is deterministic. Without going into many details, the system dynamics ƒⱼ^{d} are chosen according to a relation Gⱼ^{d} on x(k), on x(k+1) and u(k). To each solution x(·) of system Eq. (1) corresponds a trajectory of indices d_{x:}N→J indicating which system dynamics were active at the current point in time.

Assume that the set of initial conditions as well as the parameters and the inputs to the system are not precisely known, that is, x₀⊂ [symbol] , p⊂P and u⊂ [symbol] respectively. Then, theoretically for some k₀<k_{ƒ}∈N and a fixed j∈J, we could compute a set of trajectories x:[k₀,k_{ƒ}]→P( [symbol] ), which represent the evolution of the system under the system dynamics ƒⱼ^{d} for all the possible parameter values and, moreover, take into account computation errors.

Now, we can formalize the notion of robustness: Definition 1: A trajectory x of a Simulink™ model is robust if all the trajectories x′ under internal and external uncertainties and computation errors have the same trajectory of indices as x, i.e., dₓ=dx′. This definition may be employed as a validation metric. In this example case, the validation metric is robustness. Other validation metrics may also be defined and employed as well.

Informally, the above definition (Definition 1) states that the system should exhibit the same low level behavior under all given conditions and computation errors. The goal is to ascertain points in the system trajectory which are not robust. The robustness will be employed as a validation metric for the methods described below. However, other metric may also be employed. The following example, which is going to be the running example of this disclosure, presents the basic idea behind simulation non-robustness.

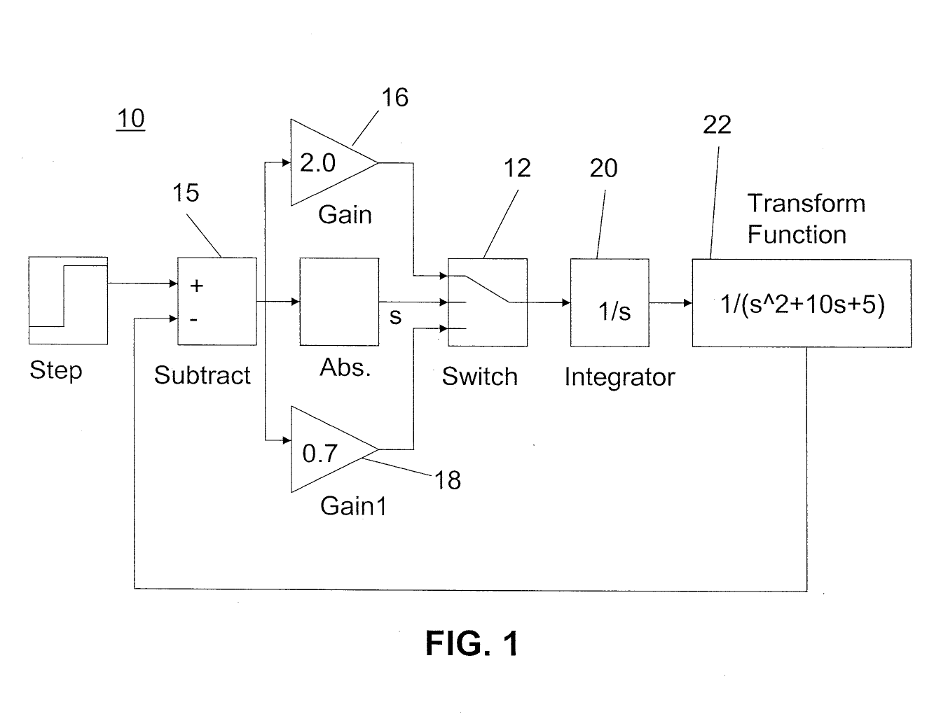

Referring now to the drawings in which like numerals represent the same or similar elements and initially to FIG. 1, an example considering a discretized system of a continuous-time model 10 is illustratively depicted. The model 10 includes a switch block 12 which determines which gain is going to be used in a feedback loop 14. The switch block connects to an integrator 20 and a transfer function 22. If the switch signal (signal s) is larger than 0.4, then “Gain” 16 is selected, otherwise “Gain1” 18 is selected. In this simple case, we want to detect situations where the numerical simulation computes a signal with value greater or equal to 4, e.g., for some k,s(k)=4.2, but the guaranteed simulation gives bounds on s which include 4, e.g., [s(k)]=[3.9,4.5]. This means that it could be the case that at a point in time the system could exhibit different dynamical behavior from the one used in the numerical simulation. We also present some results toward the solution of the above problem for continuous-time Sirulink™ models.

Problem 2: Given a continuous-time Simulink model C with piece-wise continuous dynamics and a set of uncertain initial conditions X₀ and parameters P, determine points in time when the simulation trajectory is not robust. Similar to the discrete-time case, system C can be captured by a system of linear ordinary differential equations (ODEs): \dot{x}(t)=Aⱼ(p(t))x(t)+Bⱼ(p(t))u(t)+hⱼ(p(t)) (2) where j∈J is a set of indices, t∈ [symbol] is the current point in time, x: [symbol] → [symbol] is the solution of system Eq. (2) (again, we assume that a unique solution exists u: [symbol] → [symbol] is an input to the system, p: [symbol] →P⊂ [symbol] is a (continuous) function modeling the parameters of the system and Aⱼ, Bⱼ, hⱼ are appropriately sized matrices (which are continuous with respect to the parameter vector p). At each point in time t, the system dynamics are governed by a unique differential equation: \dot{x}=Aⱼ(p(t))x(t)+Bⱼ(p(t)+hⱼ(p|t|)). As before, the system dynamics are chosen according to whether a relation Gⱼ^{c} on x(t), \dot{x}(t) and u(t) is true. To each solution x(·) of system Eq. (2) corresponds a trajectory of indices dₓ: [symbol] →J indicating which system dynamics were active at each point in time.

Analogous to the discrete-time case, we may study the behavior of the continuous-time model under uncertain initial conditions x₀⊂ [symbol] parameters p(t)⊂P and/or inputs u(t)⊂ [symbol] Then, theoretically for some t₀≦t_{ƒ} and a fixed j∈J, we could compute a set of trajectories x:[t₀,t_{ƒ}]→P( [symbol] ), which represent the evolution of the system under the system dynamics in Eq. (2) for all the possible parameter values and, moreover, take into account computation errors.

The Definition 1 of robustness also holds for continuous-time systems. However, one additional issue that appears in the case of continuous-time systems is the correctness of the computed simulation trajectory. In detail, the method employed for the numerical solution of the ODEs affects the quality of the resulting simulation and, in some cases, the solution might even diverge from the real solution. Therefore, in the continuous-time case, we also report such cases.

In one analysis, we assume that the computation adheres to the new IEEE 754-2008 standard, which is largely based on the IEEE 754-1985 norm. The general layout of a floating-point number is in sign-magnitude form, where the most significant bit is a sign bit, the exponent is stored as a biased exponent, and the fraction is the significant stored without the most significant bit. The exponent is biased by (2^{e-1})−1, where e is the number of bits used for the exponent field. For example, to represent a number which has exponent of 17 in an exponent field 8 bits wide, we store 144 since 17+(2⁸⁻¹)−1=144.

In most cases, the most significant bit of the significant is assumed to be 1 and is not stored. This case occurs when the biased exponent η is in the range 0<η<2^{e-1}. The numbers represented in that range are called normalized numbers. If the biased exponent η is 0 and the fraction is not 0, the most significant bit of the significant is implied to be 0, and the number is said to be de-normalized or sub-normal. The remaining special cases are: (1) if the biased exponent is 0 and the fraction is 0, the number is +0 (depending on the sign bit), (2) if the biased exponent equals 2^{e-1} and the fraction is 0, the number is +∞ (depending on the sign bit), which is denoted as Inf or −Inf here, and (3) if the biased exponent equals 2^{e-1} and the fraction is not 0, the number represents the special floating-point value called not a number (NaN).

Floating-point formats. For ease of presentation, we focus only on the double-precision format defined in the standard. The standard prescribes the use of 64 bits to store numbers, out of which e=11 represent the biased exponent, and 52 bits are used for the fraction. The largest number representable in double-precision is about 1.8.10³⁰⁸.

Rounding. The IEEE 754-2008 standard defines five different rounding modes that can be applicable for each floating-point operation. There are two modes that round to nearest neighboring floating point number, where a bias can be set to even numbers or away from zero. The other three rounding modes are rounding towards zero, rounding towards ∞ and rounding towards −∞. The standard defines that every arithmetic operation be calculated as precise as possible before rounding it using the current rounding mode. Computations are thus performed using longer bit-lengths and are truncated when storing the results after rounding only. While the absolute error may be large for large absolute values, the maximum relative error due to operations and rounding thus is constant for resulting values in the normalized number range. The relative error for normalized numbers is 2⁻⁵² for double-precision.

Subnormal numbers. To provide gradual underflow for very small numbers in absolute terms, the standard introduced denormalized or subnormal numbers. These numbers lie between the smallest positive normal number and zero, and their negative equivalents. This feature is meant to provide a slowing of the precision loss due to cancellation effects around zero. The main advantage of defining subnormal numbers in the standard is that it guarantees that two nearby but different floating-point numbers always have a non-zero distance. Hence, any subtraction of two nearby but different floating-point numbers is guaranteed to be non-zero. However, it should be noted that operations that result in numbers in the subnormal number range can have very large relative errors.

Operations. The standard defines many details about the precision, expected results and exception handling for a variety of operations such as arithmetic operations (add, subtract, multiply, divide, square root, . . . ), casting conversions (between formats, to and from integral types, . . . ), comparisons and total ordering, classification and testing for NaN, and many more. In this work, we will focus on arithmetic operations using the rounding precision for operations prescribed by the standard.

Interval arithmetic (IA) or interval analysis is one of the first computation models that enabled, in an efficient way, self-validating computations. IA has proven to be a valuable tool in a variety of engineering applications. Of particular interest is the application of IA to reachability problems. In IA every quantity [x] is essentially an interval [x]=[x, x̅], where the bounds x=inf[x] and x̅=sup[x] range over a particular field and x≦ x̅. We will consider the fields of the real numbers [symbol] and an “abstract” field of floating point numbers F. The corresponding sets of intervals will be denoted by R and F, respectively. The purpose of each such interval is to model potential uncertainties in the quantities and to capture internal computation errors such as rounding errors.

All the standard arithmetic operations have a corresponding operation in IA. For example, if x, y∈R, then we have:

[x, x̅]+└y, y̅┘=└x+y, x̅+ y̅┘

[x, x̅][y, y̅]=[min({xy,x y̅, x̅y, x̅y̅}), max({xy,x y̅, x̅y, x̅y̅})].

As an example consider the two intervals [−0.2, 1.1] and [0.1, 0.5]. The addition of the two interval returns [−0.1, 1.6], while the multiplication [−0.1, 0.55]. Whenever we perform an operation of an interval with a real number a, we implicitly assume that the real number is a degenerate interval, i.e., [a]=[a, a]. We will also be using interval vectors and interval matrices. For example, an n-ordered tuple of intervals [[x₁, x̅₁], . . . , [xₙ x̅ₙ]]^{T} is an interval vector [x]. In the following, we will also be using the notation □x to denote the interval vector [−x, x]ⁿ for some n≧1. Similarly, we define m×n interval matrices as members of R_{m×n} or F_{m×n}. The IA operations on vectors and matrices are the natural extensions over the real arithmetic operations.

The concept of norm plays a role in the analysis of properties of vectors and matrices. The infinity noun for real vectors is denoted by ∥·∥∞ that is, for an n-dimensional vector x, we have ∥x∥∞:=max(|x₁|, . . . , |xₙ|). In order to define the corresponding norm for interval vectors, we need to first define the absolute value of an interval number: |[x]:=max({|x|,| x̅}).

Note that the properties of the absolute value are preserved, i.e., for x, y∈R, we have |[x]+[y]≦|[x]|+|[y]| and |[x][y]|=|[x]∥[y]|. Hence, the infinity norm for interval vectors is simply defined as:

$${‖ [ x ] ‖}_{∞} := {max}_{1 \leq i \leq n} \vert [ {x}_{i} ] \vert .$$

Recall that in the case of matrices, the corresponding induced norm for an m×n matrix A is defined as

$${‖ A ‖}_{∞} = {max}_{1 \leq i \leq m} {\sum }_{j = 1}^{n} [ {a}_{ij} ] .$$

The extension of the definition of the infinity norm to interval matrices is simply ∥[A]∥_{∞}=∥max({|A|,|Ā|})∥_{∞} where the absolute value and the maximum are considered element-wise. Finally, we should reiterate that both the absolute value and the norm are not interval numbers.

We are particularly interested in using IA in order to capture floating-point rounding errors. For example, consider the number 0.1 which is not exactly representable in machine arithmetic. IA allows us to capture this number by defining an interval ↓[↓(0.1),↑(0.1)], where ↓(·) and ↑(·) are the rounding-down and up operations respectively as defined in the IEEE Floating-Point Standard. The notation [symbol] (x)=└↓(x),↑(x)┘ will also be used to bound the real value of a number. In a slight abuse of notation, we will also use [symbol] (exp) to imply that the operations in the expression exp are performed using IA even though the operants are floating-point numbers. Moreover, when we perform IA operations over floating-point numbers, we have to control the rounding mode accordingly to enclose the real value of the operation. For example, if x, y∈F than we have [x, y̅]+[y, y̅]=[↓(x+ y̅),↑( x̅+x)]. For IA computations, the IntLab library in the Matlab™ environment may be used.

IA exhibits some of the usual properties, i.e., it is associative and commutative. Moreover, it is inclusion monotone. Namely, if [x′]⊂[x] and [y′], then [x′]∘[y′]⊂[x]∘[y] where ∘∈{+.−,×,÷}. However, IA has some important deficiencies. In detail, it is sub-distributive, i.e., [x([y]+[z])]⊂[x][y]+[x][z] and, also, it has no additive and no multiplicative inverse. In general, in IA, there is no information maintained concerning the relationship of two symbolic values. Consider, for example, the interval x=[−0.1,0.1], then x−x=[−0.2,0.2]. Obviously, this is too course of a containment of the expected result, namely the degenerate interval [0] (modulo possible floating-point rounding errors). This problem is amplified in feedback control systems where one can observe a quick divergence in the enclosure of the solution due to over-approximations. Fortunately, symbolic computations using affine arithmetic can resolve this issue.

Affine Arithmetic (AA) is also a self-validated computation model that permits reasoning over ranges. AA maintains linear dependencies between AA quantities to reduce some of the over-approximation issues that are present in IA. Linear operations on AA quantities preserve such linear dependencies. However, when nonlinear operations are encountered, for example multiplication, then some small over-approximation of the actual range is introduced. AA quantities represent ranges over some field. In the following, we will be using angular brackets [symbol] [symbol] to denote symbolic variables that represent ranges in AA. Each AA variable [symbol] x [symbol] is the summation of a central value xₒ∈ [symbol] and a number of affine terms xᵢ∈ᵢ, where xᵢ∈ [symbol] is a coefficient and ∈ᵢ is a variable that ranges over [−1, 1]. Formally, we write

$$〈 x 〉 = {x}_{0} + {\sum }_{i = 1}^{k} {x}_{i} {ɛ}_{i} .$$

The interpretation of [symbol] x [symbol] is that for any x∈ [symbol] x [symbol] , for all i=1, . . . , k, there exist \tilde{∈}ᵢ∈[−1,1] such that

$$x = {x}_{0} + {\sum }_{i = 1}^{k} {x}_{i} {\tilde{ɛ}}_{i} .$$

The interval represented by [symbol] x [symbol] is simply

$$[ 〈 x 〉 ] := ⌊ {x}_{0} - {\sum }_{i = 1}^{k} \vert {x}_{i} \vert , {x}_{0} + {\sum }_{i = 1}^{k} \vert {x}_{i} \vert ⌋$$

(we should appropriately control the rounding mode in the case of floating-point numbers). For convenience, we will denote the set of all AA quantities over the reals by A [symbol] and over the floating-point numbers by AF.

Linear operations, such as addition, are straightforward to define, e.g., for x,y∈A [symbol] we have

$$( {x}_{0} + {\sum }_{i = 1}^{k} {x}_{i} {ɛ}_{i} ) + ( {y}_{0} + {\sum }_{i = 1}^{k} {y}_{i} {ɛ}_{i} ) = ( {x}_{0} + {y}_{0} ) + {\sum }_{i = 1}^{k} ( {x}_{i} + {y}_{i} ) {ɛ}_{i} .$$

On the other hand, nonlinear operations, such as multiplication, should be defined in such a way that they maintain as many linear terms as possible and, in addition, over-approximate the nonlinear terms by generating a new affine term. For example, for x, y∈A [symbol] we have

$$〈 x 〉 〈 y 〉 = {x}_{0} {y}_{0} + ( {\sum }_{i = 1}^{k} ( {x}_{0} {y}_{0} ) + {\sum }_{i = 1}^{k} ( {x}_{i} {y}_{0} ) ) {ɛ}_{i} + z {ɛ}_{k + 1}$$

where z is such that

$$\vert z \vert \geq \vert ( {\sum }_{i = 1}^{k} {x}_{i} {ɛ}_{i} ) ( {\sum }_{i = 1}^{k} {y}_{i} {ɛ}_{i} ) \vert .$$

One problem in AA is how to compute good bounds on the nonlinear terms. Whenever interval and affine quantities are mixed in an expression, we implicitly assume that the interval variable is converted into an affine variable. Similar to IA, we can define affine vectors and matrices as elements of A [symbol] and A [symbol] respectively. Furthermore, the infinity norm of an affine vector (or matrix) is simply the infinity norm of the corresponding interval vector (or matrix), i.e ∥ [symbol] x [symbol] ∥_{∞}:=∥[ [symbol] x [symbol] ]∥_{∞}. Also, since one of our goals is to account for computation errors, we take into account floating-point rounding errors. As opposed to IA, considering floating-point rounding errors in AA is more involved. We could just round outward each of the coefficients in a new affine quantity, but then the dependencies of the affine quantity on the rounding errors would be lost. To maintain as much information as possible, we can instead compute the rounding errors for each affine term separately and, then, we can accumulate the errors into a new affine term.

In other words, we can associate an affine term with the computation error that occurs at each operation. These errors and, also, the affine terms which model uncertain parameters in the system can be tracked along a computation sequence. Therefore, at each point in time, we can be cognizant of how each uncertainty affects the cut-rent state of the system but, the propagation of the affine terms helps to avoid the problems of IA due to lost dependencies between the variables. Note, however, that it is not always the case that AA computes better bounds than IA.

Since there is no publicly available affine arithmetic toolbox for Matlab™, we developed our own package AALab (Affine Arithmetic Laboratory). AALab provides a class for AA quantities and overloads most of the standard functions and operators in Matlab™ to provide AA in a transparent way to the user. In addition, AALab provides the option to take into account or ignore floating-point rounding errors. It also offers various levels of approximations for non-linear functions (e.g., trigonometric functions) and, it implements several ways of aggregating affine terms when their number becomes too large.

DETECTING NON-ROBUSTNESS IN SIMULINK™ SIMULATIONS: Self-validated computations can be realized within the Matlab™ environment or other cyber-physical model environment. These tools are used to present a framework for detecting non-robustness in discrete and continuous-time Simulink™ or other types of models.

The Simulink™ Environment: Simulink is a model-based design environment that is offered as an add-on to Matlab™. It enables the design and simulation of mixed-signal systems, i.e., systems that have both discrete and continuous-time components in a transparent way to the user. The user builds a model of the system using block diagrams such as in FIG. 1. This representation is very close to the one used by engineers when they create and study theoretical models of a system. The Simulink™ environment interfaces with numerous toolboxes that help in the analysis and semi-automatic design of control systems. However, the main strength of Simulink™—in terms of product development—is that, through the Real-Time Workshop, it can automatically generate C code for an embedded platform from the model. Some assurances or guarantees on the correctness of the model itself are needed.

Discrete-Time Simulink™ Models: Simulink™ accepts only its built-in data types, e.g., double, signal, int8, or fixed-point data types provided through the Matlab™ Fix-Point Toolbox. One way to overcome this restriction is by monitoring Simulink™ during the execution of a simulation. Namely, we first instrument Simulink™ with callback functions (listeners) using Simulink™'s Application Programming Interface (API). Then, we record the sequence of accesses and the corresponding events (such as “update” or “output”) sent to the blocks during one simulation step. Also, we maintain information about the input signals to the blocks. The advantage of inserting callbacks is that the execution order semantics of Simulink™ is enforced. In the following, we will refer to such sequences as “block execution traces”. We follow the block execution trace, but now each mathematical operation and all the relation checks are performed using self-validating computation theories such as IA or AA. The above high-level procedure appears in METHOD 1 in a very simplified presentation.

METHOD 1: RobSimDt

Input: A discrete-time Simulink(TM) model D, uncertain initial conditions
X₀, parameters P and inputs U.
Output: The robust simulation trajectory [symbol] x [symbol] and possible errors and
warnings W
1: procedure ROB SIMDT(D,X₀,P,U)

| | |
|---|---|
| 2: | [symbol] x [symbol] ₀ ← X₀,W ← θ |
| 3: | ADDLISTENERS(D) |
| 4: | T ← RUNSIMULJNK(C) [symbol] T: block access traj. |
| 5: | for k ← 1to length(T), for each block τ ∈Tₖ do |

| | |
|---|---|
| 6: | if τ is a computation block then |

| | |
|---|---|
| 7: | {τₖ, [symbol] x [symbol] ₖ} — AACOMPUTE (τ, [symbol] x [symbol] ₖ₋₁) |

| | |
|---|---|
| 8: | else [symbol] τ is a relation block, checking relation R |

| | |
|---|---|
| 9: | if R(τ.in)≠ R( [symbol] xₖ [symbol] ) then |

| | |
|---|---|
| 10: | W ← ADDWARNING(W,k,τ, [symbol] x [symbol] ₖ) |

| | |
|---|---|
| 11: | end if [symbol] τ.in are the input signals to block |

| | |
|---|---|
| 12: | end if |

| | |
|---|---|
| 13: | end for |

14: end procedure

We have implemented the above procedure into a software toolbox, we call RobSimDt (ROBust SIMulations in Discrete-Time) within the Matlab™ programming environment. RobSimDt takes as input a discrete-time Simulink™ model D and can perform guaranteed discrete-time simulation using the parameters provided in D. Since AA provides in general better bounds on the validated solution than IA, the AA computation theory is chosen by default. If the user wants to use uncertain initial conditions, parameters and/or inputs, then the user can do so by providing them to RobSimDt. In this case, the self-validated computation model employed is the one that corresponds to the data-type of the initial conditions. The output of RobSimDt is the guaranteed simulation trace and a structure which holds information on which Simulink™ blocks, time and input signal values the computation might be non-robust. The next example presents the outputs of RobSimDt on the running example.

### Example 2

Consider the continuous-time model of FIG. 1 where a transfer function block 22 has been decomposed into a basic integrator 20, sum 15 and gain blocks 16, 18. The resulting system has 3 integrators and 6 gain blocks in total. The discretization of the system was performed with the Simulink™ model discretizer using zero-order hold (zoh) and a sample step of 0.1 sec. The robustness of the simulation is determined with initial conditions [−0.1, 0.1]³ and variation of %1 in the parameter values. The Simulink™ simulation is performed with initial conditions [0 0 0]^{T} and the parameter values of Gain=2.0 (16) and Gain1=0.7 (18) as in FIG. 1. RobSimDt takes 31 sec to perform the guaranteed simulation and 5827 affine terms were generated. The result of the computation for the signal y detected 5 points where the simulation is non-robust. Below, we present how RobSimDt displays one of the warnings of possible non-robustness:

>> dispwarn (wd2, 5)
Warning 5
In the block ‘Switch’ at time 3.6
The value of the input signal to the block
was:
0.3537
while the range of the input signal computed by RobSim is:
[0.2948, 0.4126]

Next, we demonstrate how self-validated computations and robustness checks are performed. We briefly describe the procedures of two blocks of the running example: the discrete-time integrator 20 and the switch 12, for simplicity. Also, the following presentation focuses on the use of affine arithmetic as the underlying computation model which is the default option in RobSimDt. However, the application of other self-validating computation models is immediate.

Discrete-Time Integrator 20: Rob-SimDt supports a forward Euler integration (or accumulation) method. When a discrete-time integrator is accessed through an “update” event, it returns the value of the expression (x) [symbol] k [symbol] = [symbol] K [symbol] [symbol] (dt) [symbol] u [symbol] (k) which is evaluated using self-validated arithmetic. Here, [symbol] x [symbol] (k) is the (guaranteed) state of the integrator at time k, [symbol] u [symbol] (k) is the (guaranteed) input to the block at time k, K is the gain parameter of the block and dt is the sample step size. Note that we enclose the real value of dt using interval arithmetic. The exact value of dt might not be representable in machine arithmetic and, thus, if floating-point rounding errors are not accounted for, they could cause major inaccuracies in the subsequent computations. The same holds for the gain K. However, we also allow for the case that the value of the gain K is uncertain and, moreover, it might be dependent on other system parameters. Such dependencies can be modeled by letting [symbol] K [symbol] share affine terms with other system parameters. Finally, in the case where an “output” event is received, the discrete-time integrator 20 simply returns the current (guaranteed) state, i.e. [symbol] x [symbol] (k).

Switch Block 12: The switch block 12 is accessed through an “output” event. Let us assume that the threshold option in the block has been set to the option “u2>=Threshold”. This option means that the input signal u2 should be greater or equal to the threshold and that if this is true, then the upper input signal “u1” is allowed to pass through, otherwise the lower input signal “u3” is allowed to pass through. For the purposes of the following discussion let e denote the output of the switch block 12.

Now, if the formula φₛ(k)=( [symbol] u2 [symbol] (k)≧Threshold) [symbol] ( [symbol] u2 [symbol] (k)<Threshold) evaluates to false, then a robustness violation has occurred. This is a violation since either input signal [symbol] u1 [symbol] (k) or [symbol] u3(k) [symbol] could have been chosen by the switch 12 as output. Thus, in this case, we record the time, block and signal values. Moreover, since we are trying to study the robustness of a particular Simulink™ simulation, we let the switch chose the output signal according to the value of the non-guaranteed input signal u2(k).

If we are simply studying the influence of numerical errors on the computation, i.e., there is no uncertainty in the initial conditions or the system parameters besides the floating-point rounding errors, then we can also reset the guaranteed state of the output signal to the value of the corresponding non-guaranteed input signal, i.e., [symbol] ∈ [symbol] (k)= [symbol] [symbol] (ui) [symbol] (k), where i∈{1,3}. However, if this is not the case, i.e., we are also modeling external uncertainties in the variables, then the output is simply set to the corresponding guaranteed input, i.e., [symbol] ∈ [symbol] (k)= [symbol] ui [symbol] (k). where i∈{1,3}. This choice is justified since the signal u2 could be uncorrelated with the signals u1 and u3 and, also, the switch block does not impose any local invariants to the output. Note though that the fact that we simply pass the guaranteed input to the output could cause some false non-robustness warnings. On the other hand, if either sub-formula of φₛ is true at time k, then the corresponding input signal is allowed to pass through, i.e., [symbol] ∈ [symbol] (k)= [symbol] u1 [symbol] (k) or [symbol] ∈ [symbol] (k)= [symbol] u3(k) [symbol] respectively.

Continuous-Time Simulink™ Models: Problem 2 is substantially more challenging then Problem 1. One obstacle is that replacing the floating-point arithmetic with self-validating methods is not enough. Namely, the model of the system does not consist any more of ordinary differential equations, but of ordinary differential equations which are solved using a numerical integration method. Numerical integration solves the system of equations approximately and, moreover, the system of equations is bound to the problem of floating-point round errors. The only way to address this problem is by resorting to a guaranteed integration method. However, these integration methods need explicit representation of the underlying differential equations of the system. In general, such a system of mathematical equations cannot be derived automatically due to the complex nature of the Simulink™ models, e.g., switch and saturation blocks, nonlinearities etc. Note, though, that Matlab™ and Simulink™ provide linearization functions such as “Jinmod” which can extract a linear state space representation of the system around a given operating point. When the Simulink™ model is piecewise linear, one could use “linmod” to get the underlying system of ODE's to apply a guaranteed integration method. However, these linearization methods do not always extract an exact representation of the linear system even if such an exact representation exists. The following example presents how “linmod” fails to extract the correct state space model of an affine system.

### Example 3

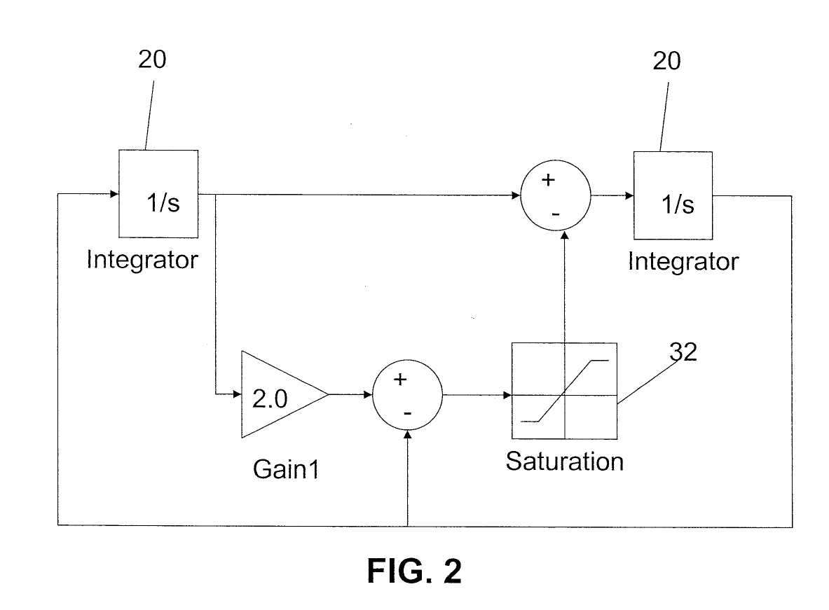

Consider the Simulink™ model in FIG. 2 which contains a non-linearity in the form of a saturation block 32. The saturation block 32 operates as follows. If the input signal is greater than an upper bound, then the output is set to the upper bound and if the input signal is lower than the lower bound, then the output of the block is set to the lower bound. In this example, the upper bound is set to 1 and the lower bound to −1. If we call the function “linmod” on the model of FIG. 2 at operating point [−1, 1]^{T} then the system \dot{x}−A₁x is derived which corresponds to the system dynamics without any saturation. However, if instead we use as operating point the value [−2, 1.6]^{T}, which causes saturation to occur, “linmod” returns the system \dot{x}=A₂x. A careful analysis of the system will reveal that the system dynamics at this operating point are affine and given by \dot{x}=A₂x+b.

In order to circumvent the deficiencies of the “linmod” and related functions, we symbolically compute the derivatives of a Simulink™ model whose dynamics are linear for a given operating point and time. For that purpose, we use our toolbox SLTrace, which was initially developed for the symbolic execution and systematic testing of Simulink™ models. Another problem that prevents us from directly employing guaranteed integrators for the solution of Problem 2 is the fact that these methods only apply to state vectors represented in interval arithmetic. However, in feedback systems, state vectors should be used with symbolic numbers in affine arithmetic. Thus, in general, the dependencies between the different variables during computation are preserved and, in turn, we reduce over-approximations through cancellations. We address the problem of integration by providing validated solutions for the system of linear ODEs which is returned by SLTrace.

1) SLTrace: SLTrace is a tool for test-generation for the Simulink™/Stateflow (S/S) design environment. It combines bounded depth symbolic execution of the linear elements in the S/S model with statistical Monte-Carlo sampling over the space of inputs obtained by symbolic execution.

METHOD 2: RobSirnCt

Input: A continuous-time affine Simulink ™ model C, uncertain initial
conditions X₀, parameters P and inputs U.
Output: The robust simulation trajectory [symbol] x [symbol] and possible errors and
warnings W
1: procedure ROBSIMCT(C,X₀,P,U)

| | |
|---|---|
| 2: | [symbol] x [symbol] ₀ ← X_{0,}W ← φ |
| 3: | {\tilde{x},t} ← SIMULINK (C) [symbol] Run Simulink |
| 4: | {\dot{x},II} ← SLTRACE(C) |
| 5: | for k ← 1 to length (t) do |

| | |
|---|---|
| 6: | {(x)ₖ [symbol] } ← STATE&BOUNDS(\dot{x}ₖ, [symbol] x [symbol] ₖ₋₁,P,U) |
| 7: | if \tilde{x}ₖ ∉ [symbol] x [symbol] ₖ then |

| | |
|---|---|
| 8: | W ← ADDERROR(W,tₖ,\tilde{x}ₖ [symbol] x [symbol] ₖ) |

| | |
|---|---|
| 9: | end if |
| 10: | if R intersects some π ∈Πₖ then |

| | |
|---|---|
| 11: | W ← ADDWARNING (W,[tₖ₋₁,tₖ],\tilde{x}ₖ,R,π) |

| | |
|---|---|
| 12: | end if |

| | |
|---|---|
| 13: | end for |

14: end procedure

The ability of SLTrace to compute symbolic constraints and derivatives of the model for a given operating point and time is considered. Given a block execution trace for each step in the simulation and for every block in the trace, a corresponding function in our Block Support Library is called to compute the corresponding symbolic states and outputs. If, in addition, the block contains a constraint or relation that must be satisfied, then this is recorded alongside with an id of the block.

2) RobSimCt: RobSimCt (Robustness of Simulations in Continuous-time) is a toolbox built in the Matlab™ programming environment which addresses Problem 2. Similar to RobSimDt, it instruments the input Simulink™ model with listeners to record the sequence of accesses to Simulink™ blocks in the model. Then, it executes the Simulink™ simulation with the default parameters of the model to produce a block execution trace. Note that for the simulation itself, Simulink™ can use any built-in numerical integration method. This is lifts any restriction of our analysis to only fixed-step algorithms.

For every time step Δtᵢ=tᵢ₊₁−tᵢ in the simulation, we pass the corresponding part of the block execution trace to SLTrace. In turn, SLTrace returns the symbolic derivatives of the linear (or affine) system for that particular time step and, also, the constraints on the state space of the model that needs to be satisfied. Using the symbolic derivatives, we can compute an enclosure of the state vector for all time between the two sampling points. Then, the enclosure is compared with the constraints to detect possible non-robustness points in the simulation. A high level description of the basic steps in RobSimCt are illustratively presented in METHOD 2.

Now, let us assume that the system dynamics as returned by SLTrace are given by the interval matrices [A], [B] and [h]. The interpretation of these matrices is that there exists a parameter function p:[tᵢtᵢ₊₁]→P such that for all t∈[tᵢt₊₁], we have A*(t)=A(p(t))∈[A],B*(t)=B(p(t))∈[B] and h*(t)=h(p(t))∈[h]. Then, for any u:[tᵢ,tᵢ₊₁]→U, the behavior of the system for the time interval [tᵢ,tᵢ₊₁] is defined by the solution of the equation: \dot{x}(t)=A*(t)x(t)+B*(t)u(t)+h*(t) (3).

We assume that either (i) the affine term h does not exist or (ii) that if h exists, then p is constant but uncertain. In the latter case, we can ignore the affine term h(p) in the initial Eq. (2), since if [A] is constant and invertible, then the simple transformation y=x+A⁻¹h can eliminate the constant term. In practice, however, since we can only determine an enclosure [h] of h this step introduces additional over-approximation in our computations. Recall that we need to verify that the Simulink™ simulation at time tᵢ₊₁ starting from time tᵢ is not false. Second, we have to check whether between time tᵢ and time tᵢ₊₁, there was no potential violation of the current model invariants. The former uses a method that computes an inclusion of the state of Eq. (3) at any time t for all possible system parameters and inputs.

Correctness of Integration: Let us first consider the case where there are no external inputs to the system, i.e., the state-space representation of the system reduces \dot{x}(t)=A*(t)x(t) Then, the solution is x(t)=Φ(t,tᵢ)x(tᵢ), where Φ(t,tᵢ)=I+∫ₜ_{ᵢ}^{t}A*(s₁)ds₁+∫ₜ_{ᵢ}^{t}A*(s₁)∫ₜ_{ᵢ}^{t}^{ₜ}A*(s₂)ds₂ds₁+ . . . is the Peano-Baker series for the transition matrix. Here, I is the identity matrix. Since each entry in A* is continuous with respect to t and the interval [tᵢ,t] is compact, by repeated applications of the mean value theorem for integrals, there exist matrices A₁*, A₂₁*, A₂₂*, . . . ∈[A] such that

$$Φ ( t , {t}_{i} ) = I + {A}_{1}^{*} ( t - {t}_{i} ) + {A}_{21}^{*} {A}_{22}^{*} \frac{{( t - {t}_{i} )}^{2}}{2} + … .$$

Note that the mean value theorem cannot be applied to A*, but to each of its entries. Hence, by the properties of IA, we derive the inclusion

$$Φ ( t , {t}_{i} ) ∈ I + ( t - {t}_{i} ) [ A ] + {\frac{{( t - {t}_{i} )}^{2}}{2} [ A ]}^{2} + … . \qquad ( 4 )$$

The above series converges to the exponential of the interval matrix:

$${e}^{[ A ] ( t - {t}_{i} )} • I + ( t - {t}_{i} ) [ A ] + {\frac{{( t - {t}_{i} )}^{2}}{2} [ A ]}^{2} + … . \qquad ( 5 )$$

Thus, we have Φ(t,tᵢ)∈e^{[A](t-t}^{ᵢ}⁾ (6). Of course, we are now faced with the computation of the exponential of an interval matrix. A conservative over-approximation [e^{[A](t-t}^{ᵢ}⁾] of e^{[A](t-t}^{ᵢ}⁾ may be provided and used. Thus, a safe inclusion of the unforced propagation of the state under rounding errors can be computed as: [symbol] x [symbol] (t)=[e^{[A](t-t}^{ᵢ}⁾] [symbol] x [symbol] (tᵢ) (7). Therefore, if the state vector \tilde{x} computed by the numerical integration at time tᵢ₊₁ is not contained in [symbol] x [symbol] (tᵢ₊₁), i.e., \tilde{x}(tᵢ₊₁)∉ [symbol] x [symbol] (tᵢ₊₁), then we know that an integration error has occurred. On the other hand, if \tilde{x}(tᵢ₊₁)∈ [symbol] x [symbol] (tᵢ₊₁), then we cannot be sure whether the integration is correct or not. In the later case, we can compute an under-approximation of the interval matrix exponential and provide some inner bounds on the reachable set. However, this also necessitates the computation of inner bounds in interval and affine arithmetic.

Both numbers tᵢ and tᵢ₊₁ are machine representable floating-point numbers since they are computed during the Simulink™ simulation. Nevertheless, their difference Δtᵢ=tᵢ₊₁−tᵢ might not be exactly representable in machine arithmetic, hence in Eq. (7) we rigorously bound t−tᵢ using interval arithmetic. Next, we have to take into account the influence of potential inputs or noise to the system, that is, the case where B*≠0: x(t)=Φ(t,tᵢ)x(tᵢ)+∫ₜ_{ᵢ}^{t}Φ(t,s)B(s)u(s)ds. For any s∈[tᵢ,t], we have B(s)∈[B], u(s)∈[u] and, also, from Eqs. (6) and (10) by ignoring rounding control, we have Φ(t,s)∈[e^{[A](t-s)}]. By a change of variables σ=t−s we get dσ=−ds and ∫ₜ_{ᵢ}^{t}Φ(t,s)B(s)u(s)ds∈∫₀^{t-t}^{ᵢ}[e^{[A]σ}]dσ[B][u]. From (10), we also get:

$${\int }_{0}^{t - {t}_{i}} ( I + {\sum }_{k = 1}^{m} {\frac{1}{k !} [ A ]}^{k} {σ}^{k} + E ( [ A ] σ ) ) d σ = I ( t - {t}_{i} ) + {\sum }_{k = 1}^{m} {\frac{{( t - {t}_{i} )}^{k}}{( k + 1 ) !} [ A ]}^{k} + {\int }_{0}^{t - {t}_{i}} E ( [ A ] σ ) d σ$$

E([A]σ) is monotone (actually increasing) with respect to σ. Thus, ∫₀^{t-t}E([A]σ)dσ⊂E([A](t−tᵢ))∫₀^{t-t}^{ᵢ}dσ=E([A](t−tᵢ)(t−tᵢ). The above informal results can be summarized in the following theorem where internal computation errors are also taken into account.

Theorem 1: Consider the time interval Tᵢ=[tᵢ,tᵢ₊₁] and a continuous parameter function p:Tᵢ→P such that for all t∈Tᵢ the matrices A*(t)=A(p(t))∈[A] and B*(t)=B(p(t))∈[B] are continuous in each of their entries with respect to t. Also, let Δtᵢ=tᵢ₊₁−tᵢ and m be the order of the Taylor terms. Then, for any continuous input function u:Tᵢ→U such that for all we have u(t)∈[u], the system \dot{x}(t)=A*(t)x(t)+B*(t)u(t) with initial conditions in [symbol] x [symbol] (tᵢ) has a solution at time tᵢ₊₁ which is guaranteed to lie in affine set

$$〈 x 〉 ( {t}_{i + 1} ) = [ {e}^{[ A ] ( Δ {t}_{i} )} ] 〈 x 〉 ( {t}_{i} ) + I ( Δ {t}_{i} ) ++ {\sum }_{k = 11}^{m} ↕ {( \frac{Δ {t}_{i}^{k}}{( k + 1 ) !} ) [ A ]}^{k} + E [ A ] ↕ ( Δ {t}_{i} ) ↕ ( Δ {t}_{i} ) \qquad ( 8 )$$

under finite precision arithmetic.

Constraint Violation: Next, we need to address the problem of possible violation of the location invariant constraints. This step is straightforward. Along with the symbolic derivatives, SLTrace also returns the invariant constraints that hold at each point in time in the simulation. More formally, for each time step [tᵢ,tᵢ₊₁], we have a set of constraints Πᵢ={αⱼx+βⱼu+γⱼ≦0}_{j∈J}, which is indexed by the block id where the relation check took place. All we need to do then is to check that for all t∈[tᵢ,tᵢ₊₁] and for all j∈J, the relation αⱼx+βⱼu+γⱼ≦0 is satisfied. From Eq. (8), we cannot perform these checks analytically. Therefore, once more we must conservatively bound the state of the system between times tᵢ and tᵢ₊₁, that is, we have to compute a set [symbol] R [symbol] such that [symbol] x [symbol] (t)⊂ [symbol] R [symbol] for all t∈[tᵢ,tᵢ₊₁].

Toward that goal, we consider an initial state x(tᵢ)∈ [symbol] x [symbol] (tᵢ) and the final value of the trajectory at time tᵢ₊₁, i.e., x(tᵢ₊₁)=Φ(tᵢ₊₁,tᵢ)x(tᵢ). For any t∈[tᵢ,tᵢ₊₁], we consider the approximation of Φ(t,tᵢ)x(tᵢ) by the linear approximation

$$x ( {t}_{i} ) + \frac{t - {t}_{i}}{{t}_{i + 1} - {t}_{i}} ( Φ ( {t}_{i + 1} , {t}_{i} ) x ( {t}_{i} ) x ( {t}_{i} ) - x ( {t}_{i} ) ) .$$

Let as denote the difference between the actual value and its approximation by δ(t), that is,

$$δ ( t ) = Φ ( t , {t}_{i} ) x ( {t}_{i} ) - x ( {t}_{i} ) - \frac{t - {t}_{i}}{{t}_{i + 1} - {t}_{i}} ( Φ ( {t}_{i + 1} , {t}_{i} ) x ( {t}_{i} ) - x ( {t}_{i} ) )$$

Using Eq. (6), the fact that x(tᵢ)∈ [symbol] x [symbol] (tᵢ) and the properties of AA, we get:

$$δ ( t ) ∈ ( {e}^{[ A ] ( t - {t}_{i} )} ) - I - \frac{t - {t}_{i}}{{t}_{i + 1} - {t}_{i}} ( {e}^{[ A ] ( {t}_{i + 1} - {t}_{i} )} - I ) 〈 x 〉 ( {t}_{i} ) = {\sum }_{k = 2}^{∞} {\frac{( t - {t}_{i} ) ( {( t - {t}_{i} )}^{k - 1} - {( {t}_{i + 1} - {t}_{i} )}^{k - 1} )}{k !} [ A ]}^{k} 〈 x 〉 ( {t}_{i} ) .$$

Now, we are in position to use Theorem 3 in order to conservatively enclose δ(t) in the set [Δ] [symbol] x [symbol] (tᵢ) where

$$[ Δ ] = {\sum }_{k = 2}^{m} {[ ( {k}^{\frac{- k}{k - 1}} - {k}^{\frac{- 1}{k - 1}} ) \frac{{( t - {t}_{i} )}^{k}}{k !} , 0 ] [ A ]}^{k} + • E ( [ A ] ( t - {t}_{i} ) ) .$$

Up to now, we saw how to compute a bound on the divergence of x(t) from the line that connects x(tᵢ) and x(tᵢ₊₁). To account for all such trajectories between [symbol] x [symbol] (tᵢ) and [symbol] x [symbol] (tᵢ₊₁) (without input), we simply have to compute the convex hull of the sets [symbol] x [symbol] (tᵢ).and [symbol] x [symbol] (tᵢ₊₁). Such a set cannot be computed. Others have over-approximated the convex hull with a new zonotope. We instead compute the interval convex hull (CH) of the two symbolic sets. This gives us a quick, but conservative, enclosure of the convex hull without introducing any new internal computation errors. Thus, the resulting set enclosure for the state vector between times tᵢ and tᵢ₊₁ (without input) is

[R]=CH([ [symbol] x [symbol] (tᵢ)],[ [symbol] x [symbol] (tᵢ₊₁)])+[Δ][ [symbol] x [symbol] (tᵢ)], (9)

where for some [x], [y]∈ [symbol] , we have CH([x],[y])=└min(x,y),max( x̅, y̅)┘. The next theorem summarizes the above results under the presence of inputs to the system.

Theorem 2: Consider the time interval Tᵢ=[tᵢ,tᵢ₊₁] and a continuous parameter function p:Tᵢ→P such that for all t∈Tᵢ the matrices A*(t)=A(p(t))∈[A] and B*(t)=B(p(t))∈[B] are continuous in each of their entries with respect to t. Then, for any continuous input function u:Tᵢ→U such that for all t∈Tᵢ we have u(t)∈[u], the system \dot{x}(t)=A*(t)x(t)+B*(t)u(t) with initial conditions in [symbol] x [symbol] (tᵢ) has a solution x(t) that it is guaranteed to lie in the set

$$[ R ] = CH ( [ 〈 x 〉 ( {t}_{i} ) ] , [ [ {e}^{[ A ] ↕ ( Δ {t}_{i} )} ] 〈 x 〉 ( {t}_{i} ) ] ) ++ ( {\sum }_{k = 2}^{m} {[ λ ( k , Δ {t}_{i} ) , 0 ] [ A ]}^{k} + E ( [ A ] ( Δ {t}_{i} ) ) ) [ 〈 x 〉 ( {t}_{i} ) ] ++ I ↕ ( Δ {t}_{i} ) + {\sum }_{k = 1}^{m} ↕ {( \frac{Δ {t}_{i}^{k}}{( k + 1 ) !} ) [ A ]}^{k} + E ( [ A ] ↕ ( Δ {t}_{i} ) ) ↕ ( Δ {t}_{i} )$$

under finite precision arithmetic. Here,

$$Δ {t}_{i} = {t}_{i + 1} - {t}_{i} , λ ( k , Δ {t}_{i} ) = inf ↕ ( ( {k}^{\frac{- k}{k - 1}} - {k}^{\frac{- 1}{k - 1}} ) \frac{Δ {t}_{i}^{k}}{k !} )$$

and m is the order of the Taylor terms.

Now that we have an over-approximation of the reachable set between samples tᵢ and tᵢ₊₁, we can perform the check for guard violation by simply checking whether αⱼ[R]+βⱼ[u]+γⱼ≦0 for all j∈J. As mentioned before, if any of these checks fails, then we keep the corresponding information. Moreover, if we would like to reduce the number of false warnings of intersections with the invariant constraints, whenever such an intersection is detected, we repeat the check by now over-approximating the two symbolic sets [symbol] x [symbol] (tᵢ) and [symbol] x [symbol] (tᵢ₊₁) with a new symbolic set in AA, that is, [symbol] R [symbol] =CH( [symbol] x [symbol] (tᵢ), [symbol] x [symbol] (tᵢ₊₁))+[Δ] [symbol] x [symbol] (tᵢ). For an approximation of the convex hull of two affine numbers see the computation of the convex hull of two zonotopes.

The present embodiments employ Affine arithmetic which captures floating-point errors. The aim is to address the robustness of a particular simulation with respect to internal and external uncertainties in the system, as opposed to computing system invariants and determining how floating-point rounding errors propagate through the computation. RobSimDt determines the robustness of a trajectory of a discrete-time hybrid system, and RobSimDt can account for internal computation errors. Further, the present embodiments, take into account the possible numerical drift in the computation of time and, model and capture internal computation errors. Moreover, since we consider variable time step integration methods, we perform the set approximations at each step of the simulation. This necessitates over-approximations that avoid matrix operations as much as possible. RobSimCt studies the robustness and correctness of a particular simulation.

A framework is presented for reporting potential points where a Simulink™ simulation might not be robust. The present solution can model and capture both uncertainties in the model and internal computation errors. In addition, in the case of continuous-time Simulink™ models with piecewise affine dynamics, we can also detect points where the numerical integration is not correct. One advantage is that the present embodiments are non-intrusive, i.e., we let the simulation execute and, then, we analyze the resulting trajectories (both the Simulink™ trajectory and the block execution trace). Therefore, we overcome the key challenge of deciphering Simulink™ semantics and, moreover, we avoid translating the model into a formalism such as a hybrid automaton.

The present embodiments find utility as an analysis tool on top of a Simulink™ simulation or comparable systems and provide guarantees that the computation itself is correct against modeling uncertainties and floating-point rounding errors. Especially, the latter types of errors can be quite stealthy as we have indicated in the introduction. In addition, possible points of non-robustness in the simulation can be further explored by some light weight method such as Monte-Carlo simulations.

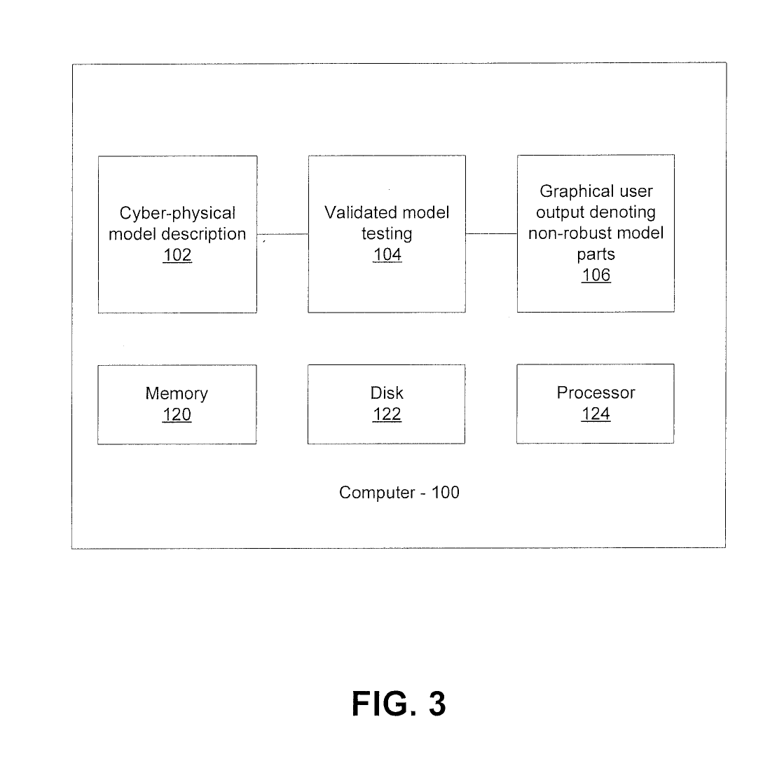

Referring to FIG. 3, a general purpose computer device 100 is illustratively shown adapted in accordance with the present principles. Computer 100 includes memory 120, disks 122, a processor (CPU) 124 and any other peripherals or interface devices and systems, such as a display 106, etc. Computer 100 stores a model 102, such as a cyber-physical model, which may be employed in any number of applications. The model 102 may be employed for a circuit, a mechanical system, or any other physical or virtual device of system. For the model 102 of a system, in particular, a cyber-physical system, validated model testing is performed in block 104. The testing preferably includes checking for robustness of each execution trace model simulations. A simulation model is obtained using symbolic execution as well as for validation properties. The results of the testing include outputting of non-robust model parts that were identified (106).

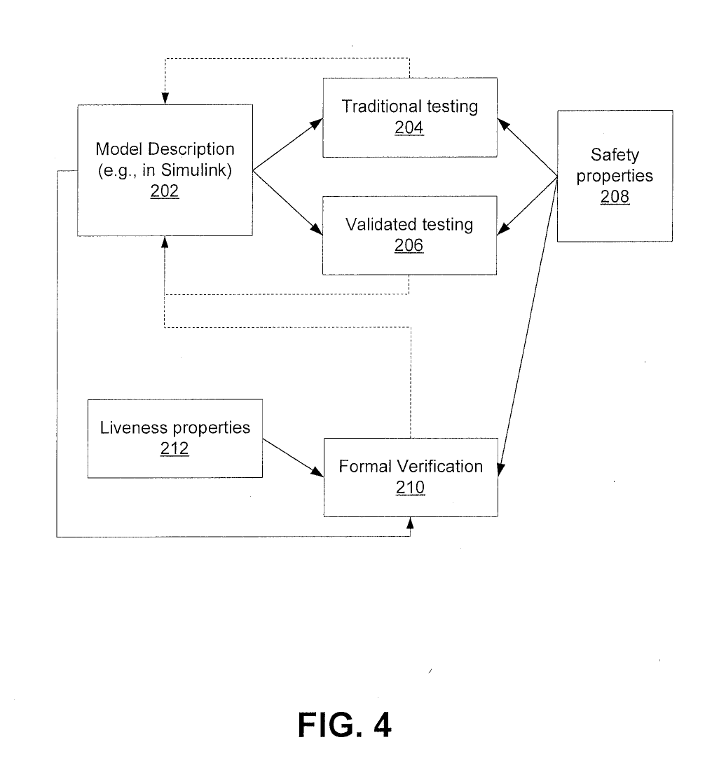

Referring to FIG. 4, non-robustness testing may be introduced into modeling tools, such as Simulink™/Stateflow environment, and provide an improved design flow for the user. In addition to traditional testing 204, the user can now utilize robustness checking using a validated testing environment 206. Note that formal verification 210 is even more precise and can handle more applications. Safety properties 208 may be defined or provided as specification for the testing. A formal verification program 210, which may include liveness or other test parameters (validation metrics), as input to the formal verification program 210. The model description 202 is tested accordingly in an iterative manner. In accordance with the present principles, the model 202 is tested as part of the simulation, but the results and methodology are also tested for robustness. In this way, the present results will provide a higher level of confidence, and improved accuracy.

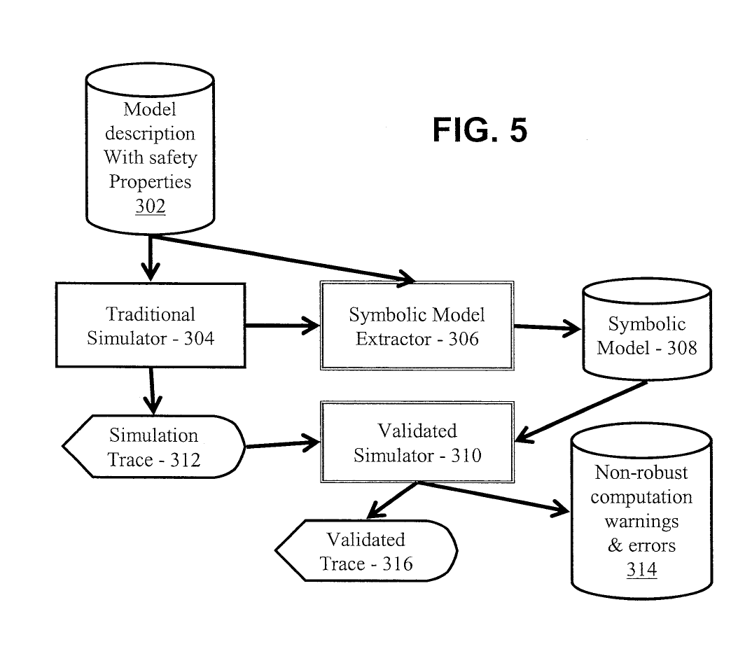

Referring to FIG. 5, a testing flow for a model description 302 with safety properties is illustratively shown. The validated testing flow is based on capturing the model step-by-step symbolically using a symbolic model extractor 306 to create a symbolic model 308 of the model 302. The simulation model is obtained using symbolic execution. A traditional simulator 304 is also employed and simulates the model 302 to output simulation traces 312. The simulation traces 312 are then rerun one at a time using a validated simulator 310. The validated simulator 310 produces a validate trace 316 that includes the original trace (312), but also covers other potential traces that are due to non-robustness of the model 302 or the floating-point computations involved in the simulation. The validated simulator 310 outputs non-robust computation warnings and errors in block 314. The output in block 314 may be employed to improve the model 302, alter the safety properties (e.g., change the bounds) and/or adjust the computational parameters or process steps to make the model computations more robust.

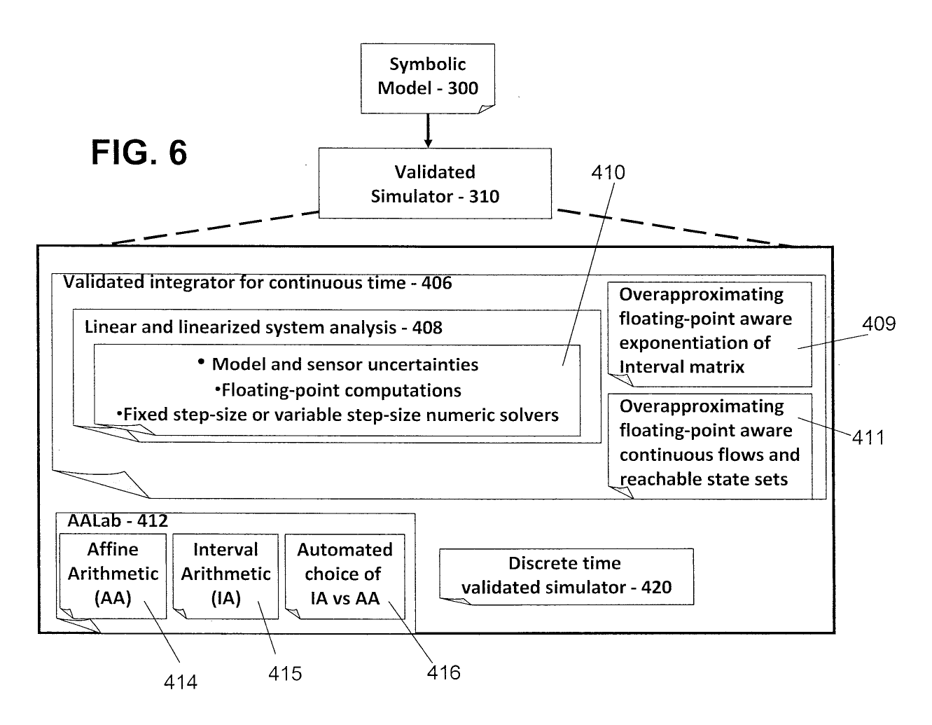

Referring to FIG. 6, a symbolic model 308 provided input to a validated simulator 310. The validated simulator 310 includes validated simulation of continuous-time model blocks. A validated integrator 406 for continuous-time linear systems that can handle model uncertainties and is aware of floating-point numerical computations for fixed step-size or variable step-size numeric solvers. The integrator 406 includes a module 408 to perform linear and linearized system analysis as described above with reference to the working example in FIGS. 1 and 2. Such system analysis may include a module 410 for identifying and addressing model and sensor uncertainties, floating point computations, fixed step size or variable step size numeric solvers, etc. The integrator 406 includes a module 409 for over-approximating exponentiation of an interval matrix and a module 411 for over-approximating continuous-time flows. The modules 409 and 411 permit conservative over-approximations for floating-point computations. The over-approximations are provided in exponentiations of interval matrices when interval ranges are employed (409) and for continuous flows and reachable state sets (411). The theory of linear system reachability is employed to guarantee the correctness of numerical simulations under model uncertainties and, under floating-point rounding uncertainties.

In accordance with the present principles the AALab 412 provides affine arithmetic (AA) 414 and interval arithmetic (IA) 415 functions. AALab library 412 allows AA object manipulation with floating-point rounding control in a transparent way to the user. In addition, AALab 412 provides the option to take into account or ignore floating-point rounding errors. It also offers various levels of approximations for non-linear functions (e.g., trigonometric functions) and, it implements several ways of aggregating affine terms when their number becomes too large. AALab 412 includes a module 416 for automatically selecting a preferred method AA versus IA depending on the circumstances. A discrete time validated simulator 420 is included in the validated simulator 310. Simulator 420 computes validated simulations for the discrete-time model components.

The simulator 310 outputs a validated testing flow for performing test on the model 302. The simulator 310 handles variable step-size numeric solvers in the context of floating-point computations and model uncertainties. The simulator 310 is capable of providing over-approximating exponentiation of the interval matrix in a domain, and can handle computing continuous flow for such computations. Testing verification software may include a module in accordance with the present principles that can test for robustness of tests. This can then be used in an improved design flow for systems that cannot be fully formally verified. Each test case can now be utilized to find inherent problems that were not visible in a single numeric simulation.

Having described preferred embodiments of a system and method for robust testing for discrete-time and continuous-time system models (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for testing robustness of a simulation model for continuous time systems, comprising:
computing a set of symbolic simulation traces for a simulation model for a continuous time system stored in memory, using a discrete time simulation of given test inputs stored in memory;
accounting for simulation errors due to at least one of numerical instabilities and numeric computations;
validating the set of symbolic simulation traces with respect to validation properties in the simulation model; and
identifying portions of the simulation model description that are sources of the simulation errors.

2. The method as recited in claim 1, wherein the simulation model is extracted from a cyber-physical system or system model by applying the given test inputs, the simulation model being stored as a mixed discrete/continuous hybrid system in memory.

3. The method as recited in claim 2, wherein the simulation model includes a symbolic representation by creating a linearized symbolic model for each of a plurality of execution time steps.

4. The method as recited in claim 1, wherein the validation properties include one of validation metrics defined using simulation model elements and safety properties embedded in the simulation model.

5. The method as recited in claim 1, wherein validating includes employing self-validated arithmetic functions to check for errors.

6. The method as recited in claim 5, wherein the self-validated arithmetic functions include at least one of interval arithmetic and affine arithmetic.

7. The method as recited in claim 5, further comprising selecting a self-validated arithmetic function suitable for a given symbolic model.

8. The method as recited in claim 1, wherein the at least one of numerical instabilities and numeric computations include floating-point rounding errors and system modeling uncertainties.

9. The method as recited in claim 1, wherein the simulation model includes specification of safety properties, and errors include violations of safety properties.

10. The method as recited in claim 1, wherein validating includes accounting for internal computation errors by floating-point aware over-approximation of the exponentiation of an interval matrix.

11. The method as recited in claim 1, wherein validating includes accounting for internal computation errors by floating-point aware over-approximation of continuous flows and reachable state sets.

12. A computer readable storage medium comprising a computer readable program for testing robustness of a simulation model for continuous time systems, wherein the computer readable program when executed on a computer causes the computer to perform the steps of:
computing a set of symbolic simulation traces for a simulation model for a continuous time system stored in memory, using a discrete time simulation of given test inputs stored in memory;
accounting for simulation errors due to at least one of numerical instabilities and numeric computations;
validating the set of symbolic simulation traces with respect to validation properties in the simulation model; and
identifying portions of the simulation model description that are sources of the simulation errors.

13. The computer readable storage medium as recited in claim 12, wherein the simulation model is extracted from a cyber-physical system or system model by applying the given test inputs, the simulation model being stored as a mixed discrete/continuous hybrid system in memory.

14. The computer readable storage medium as recited in claim 13, wherein the simulation model includes a symbolic representation by creating a linearized symbolic model for each of a plurality of execution time steps.

15. The computer readable storage medium as recited in claim 12, wherein the validation properties include one of validation metrics defined using simulation model elements and safety properties embedded in the simulation model.

16. The computer readable storage medium as recited in claim 12, wherein validating includes employing self-validated arithmetic functions to check for errors.

17. The computer readable storage medium as recited in claim 16, wherein the self-validated arithmetic functions include at least one of interval arithmetic and affine arithmetic.

18. The computer readable storage medium as recited in claim 12, wherein the at least one of numerical instabilities and numeric computations include floating-point rounding errors and system modeling uncertainties.

19. The computer readable storage medium as recited in claim 12, wherein validating includes accounting for internal computation errors by floating-point aware over-approximation of the exponentiation of an interval matrix.

20. The computer readable storage medium as recited in claim 12, wherein validating includes accounting for internal computation errors by floating-point aware over-approximation of continuous flows and reachable state sets.

21. A system for testing robustness of a cyber-physical model, comprising:
a symbolic model extractor stored in memory storage and configured to generate a symbolic representation of a model description by applying test inputs stored in the memory storage;
a test simulator configured to run tests on the model description to generate simulation traces for the model description; and
a validated simulator configured to generate and validate a set of simulation traces corresponding to the symbolic representation, to account for errors due to at least one of numerical instabilities and numeric computations, the validated simulator including a self-validated arithmetic function library to handle the numerical instabilities and numeric computations such that portions of the model description are identified by the validated simulator that are sources of the errors.

22. The system as recited in claim 21, wherein the self-validated arithmetic function library includes at least one of interval arithmetic and affine arithmetic.

23. The system as recited in claim 21, wherein the at least one of numerical instabilities and numeric computations include floating-point rounding errors and system modeling uncertainties.
